(19) United States
(12) Patent Application Publication
(10) Pub. No.: US 2010/0304719 A1
(43) Pub. Date: Dec. 2, 2010

(54) SETTING PHONE PROFILES USING CALENDAR AVAILABILITY STATUS

(76) Inventor: Rohit Deep, Union City, CA (US)

Correspondence Address: CESARI AND MCKENNA, LLP, 88 BLACK FALCON AVENUE, BOSTON, MA, 02210, US

(21) Appl. No.: 12/474,330

(22) Filed: May 29, 2009

(51) Int. Cl. H04M 3/00

(52) U.S. Cl. 455/413; 455/418

(57) ABSTRACT

In one embodiment, availability times of a particular user may be obtained from an online calendar of that particular user, and based on a current time as applied to the availability times, a current availability status may be correspondingly determined. As such, a phone profile of the particular user may be set based on the current availability status and one or more phone profile policies, the phone profile policies defining phone-based parameters to be set according to particular availability statuses.

### TECHNICAL FIELD

The present disclosure relates generally to computer networks, and more particularly, to phone profiles and online calendar status.

### BACKGROUND

Generally, phone users desire (or should) set their phone's ring tone to a less disturbing mode (e.g., off/silent/vibrate) when the user is busy (e.g., in a meeting) and regular ringing when the user is free. Sometimes, however, the users forget, and their phone rings at an inopportune time (e.g., in an important meeting). Also, voicemail for a user's phone is generally set as a single message. These single messages are generally very generic, and give no insight to a caller as to whether the user is free and simply does not answer the phone, or if the user is busy (e.g., in a meeting) and is unable to answer the phone, and for how long that will be the case.

### BRIEF DESCRIPTION OF THE DRAWINGS

The advantages of the invention may be better understood by referring to the following description in conjunction with the accompanying drawings in which like reference numerals indicate identically or functionally similar elements, of which:

FIG. 1 illustrates an example online calendar;

FIG. 2 illustrates an example computer/communications network;

FIG. 3 illustrates an example device;

FIG. 4 illustrates an example logical view of a phone profile process;

FIG. 5 illustrates an example procedure for setting phone profiles based on calendar status;

FIG. 6A illustrates an example state diagram for changing phone ring tone profiles;

FIG. 6B illustrates an example policy mapping of ring tone profiles; and

FIG. 7 illustrates an example policy mapping of voicemail profiles.

### DESCRIPTION OF EXAMPLE EMBODIMENTS

### Overview

According to one or more embodiments of the disclosure, availability times of a particular user may be obtained from an online calendar of that particular user, and based on a current time as applied to the availability times, a current availability status may be correspondingly determined. As such, a phone profile of the particular user may be set based on the current availability status and one or more phone profile policies, the phone profile policies defining phone-based parameters to be set according to particular availability statuses. For instance, according to one or more embodiments of the disclosure, the phone profile may be set to adjust a ring tone of a phone based on the availability status, and/or to select a particular voicemail message.

### Description

Online calendars, such as, e.g., the Microsoft® Exchange (or Outlook) Calendar program, the iCal (or iCalendar) calendar program available from Apple Inc.®, or the Google Calendar available from Google®, are generally known and understood by those skilled in the art. As used herein, the term “online calendar” simply refers to a software-based calendar program that may be accessible through a computer network (and need not imply that the calendar is accessible via a web browser). Online calendars (or “calendars” herein) may be used to track events and appointments (e.g., meetings, etc.) for a calendar user in order to identify conflicts and free time.

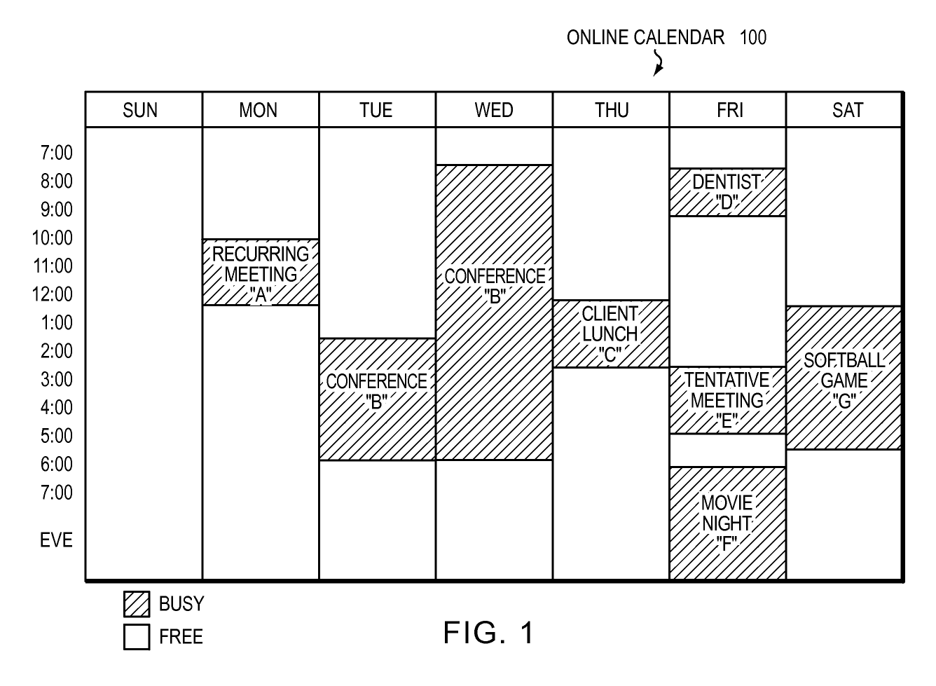

FIG. 1 illustrates an example online calendar view 100 that may be appreciated by those skilled in the art. For instance, in a weekly view, days from Sunday through Saturday are shown, being illustratively divided into hourly time slots, shown from 7:00 AM to 7:00 PM. Various scheduled times or “busy” times (events, appointments, etc.) are shown, generally denoted as “A-G,” while any time not otherwise indicated as such is referred to as “free” time. In addition to being visually useful for keeping track of events, online calendars may provide event reminders (e.g., in advance of the event) through on screen pop-up messages, email, SMS (“text”) messages, pages, etc. Also, online calendars may be shared with other calendar users to allow those other users to view (or subscribe to) a particular user's calendar, and to thus allow more efficient scheduling.

As previously mentioned, online calendars may be accessible through a computer network, such as the Internet, so the calendars can be shared and synchronized (“synced”) with other devices, such as personal computers (PCs), laptops, mobile/cellular phones, smart phones, smart devices, personal digital assistants (PDAs). For example, the devices may have software applications that access the calendar's management database (e.g., a Microsoft Exchange Server®, etc.) through a computer (or communication) network, such as through the Internet or mobile phone communication network.

Generally, a computer/communications network is a geographically distributed collection of nodes interconnected by communication links and segments for transporting data or signals between end nodes, such as PCs, phones, etc. The Internet is an example of a network that connects disparate networks throughout the world, providing global communication between nodes on various networks. The nodes in a computer network may by exchanging discrete frames or packets of data according to predefined protocols, such as the Transmission Control Protocol/Internet Protocol (TCP/IP). Alternatively or in addition, other communication protocols, such as common carrier telephone lines (POTS), mobile phone communications (e.g., cellular, satellite), etc., may be used to interconnect the devices on the network.

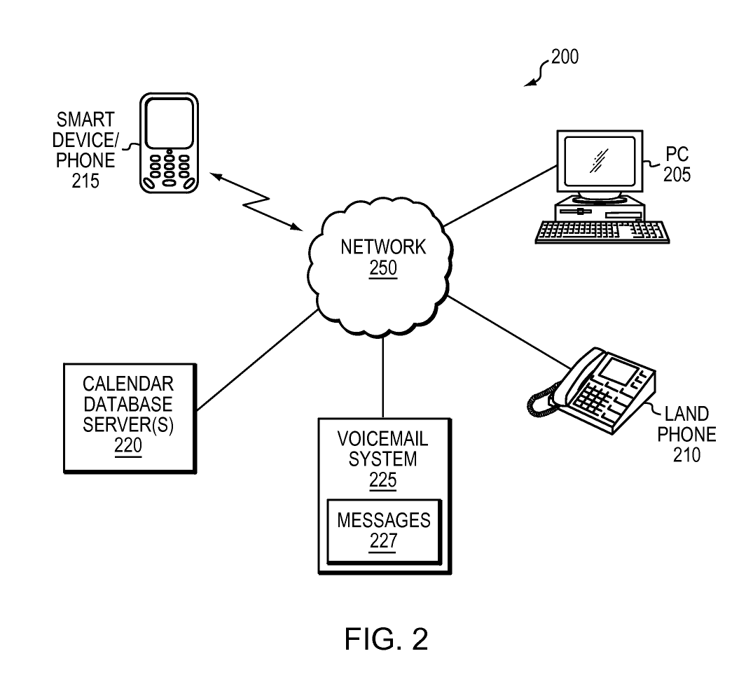

FIG. 2 is a schematic block diagram of an example computer or communications network 200 illustratively comprising nodes/devices, such as one or more PCs 205, land-line (or desktop) phones 210 (e.g., IP phones), and smart devices/phones 215 (e.g., mobile phones), interconnected by the network could 250 as shown. Illustratively, a calendar database server 220 may also be interconnected with the network 250, as well as a voicemail system 225 (as described below). Those skilled in the art will understand that any number of nodes, devices, links, etc. may be used in the computer network, and that the view shown herein is for simplicity.

The devices in the network 200 may each communicate with the calendar database server 220 to sync a user's calendar between the devices (e.g., pulling information used to fill in the calendar 100.) That is, a user may alter the contents of the calendar from one device (e.g., PC 205), and may wish to access the calendar from another device (e.g., phone 215), so the server 220 may store and distribute the contents accordingly. Note that calendars may also be stored on a particular device, and that syncing a calendar may occur between devices without an intermediary server. Note also that where the techniques described herein generally relate to calendars stored in a database, the calendar may be simply stored on the device itself, without needing an interconnection with a computer network (e.g., a PDA calendar without Internet connectivity).

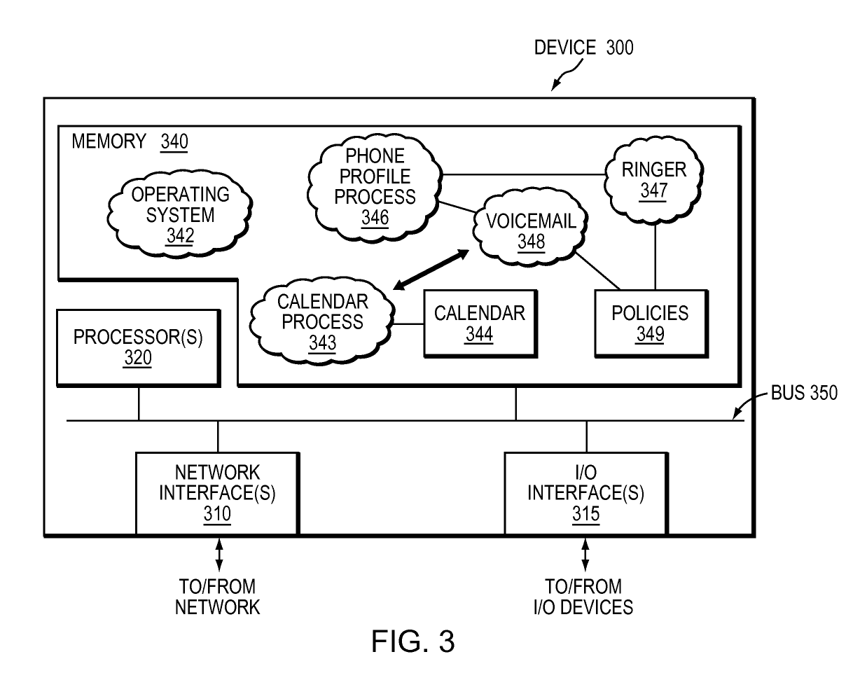

FIG. 3 is a schematic block diagram of an example device 300 that may be advantageously used with one or more embodiments described herein, e.g., a PC 205, phone 210, phone/device 215, or, in certain embodiments, voicemail system 225 (or calendar database server 220). The device may comprise at least one network interface 310, input/output (I/O) interfaces 315, one or more processors 320, and a memory 340 interconnected by a system bus 350. The network interface(s) 310 contain the mechanical, electrical, and signaling circuitry for communicating data over physical links coupled to the network 350. The network interfaces may be configured to transmit and/or receive data using a variety of different communication protocols, including, inter alia, TCP/IP, wireless protocols, mobile/cellular protocols, satellite protocols, etc. Also, I/O interfaces 315 contain the mechanical, electrical, and signaling circuitry for communicating with one or more I/O devices, such as a keyboard, mouse, stylus, touch-screens, displays, monitors, speakers, etc. (not shown).

The memory 340 comprises a plurality of storage locations that are addressable by the processor(s) 320 for storing software programs and data structures associated with the embodiments described herein. The processor 320 may comprise necessary elements or logic adapted to execute the software programs and manipulate the data structures, such as, in certain embodiments, a calendar 344 and policies 349. An operating system 242 (e.g., various versions of Mac OS, Windows, Linux, BSD, Solaris, proprietary operating systems, etc., as understood by those skilled in the art), portions of which are typically resident in memory 340 and executed by the processor(s), functionally organizes the device by, inter alia, invoking operations in support of software processes and/or services executing on the device. These software processes and/or services may comprise a calendar process 343 and a phone profile process 346 as described herein, in addition to other device specific processes/programs (e.g., communication processes, etc.). It will be apparent to those skilled in the art that other types of processors and memory, including various computer-readable media, may be used to store and execute program instructions pertaining to the inventive technique described herein.

As noted above, device users should set their device's volume, such as system sounds, or illustratively, a phone's ring tone, to a less disturbing mode (e.g., off/silent/vibrate) when the user is busy (e.g., in a meeting) and regular ringing when the user is free. If the user forgets, their phone may ring at an inopportune time (e.g., in an important meeting). Also as noted above, voicemail for a user's phone is generally set as a single message. These single messages are typically generic, and give no insight to a caller as to whether the user is free and simply does not answer the phone, or if the user is busy (e.g., in a meeting) and is unable to answer the phone, and for how long that will be the case.

Currently, certain phones/devices have the ability to switch phone profiles based on predetermined time of day. For instance, one or more cell phone manufacturers provide functionality that change the profile based on time, such as setting a ring tone to “vibrate” at 9:00 AM and back to “normal” at 5:00 PM (where the user can select these two times). These features, however, are not dynamic, and do not accurately reflect the state of the user during the day (e.g., all meetings may not fall within this time, or the user may not wish to have the phone ring differently when not actually occupied). Also, some systems similarly allow voicemail messages to change based on time of day, inside/outside callers, etc., but again, these messages are not dynamic based on whether a user is currently free or busy, and generally provide no insight to the user's activity or availability (current or future).

According to one or more embodiments described herein, a phone profile of the particular user may be set based on the current availability status of a user's corresponding online calendar (also referred to as a “free/busy” status in the art of online calendars) as applied to one or more phone profile policies (which define phone-based parameters to be set according to particular availability statuses). For instance, according to one or more embodiments of the disclosure, the phone profile may be set to adjust a ring tone of a phone based on the availability status, and/or to select a particular voicemail message.

Illustratively, the techniques described herein may be performed by hardware, software, and/or firmware, such as in accordance with a phone profile process 346, which may contain computer executable instructions executed by the processor 220 to perform functions relating to the novel techniques described herein. In addition, phone profile process may operate in conjunction with calendar process 343 operating in a conventional manner and/or in a manner as described herein, and which also may contain computer executable instructions executed by the processor 220 to perform corresponding functions.

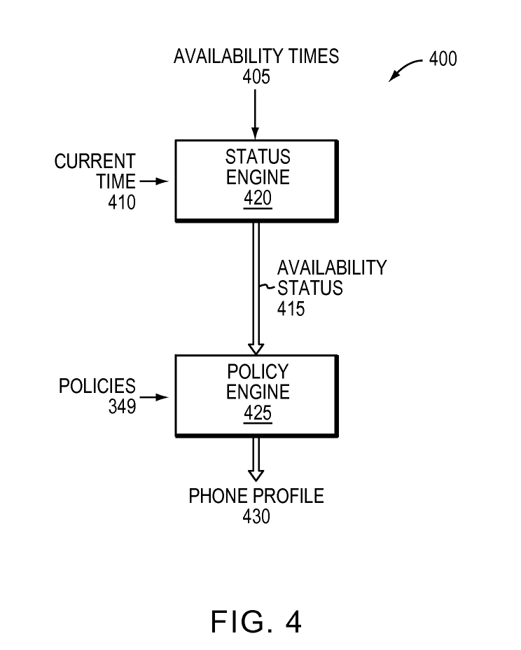

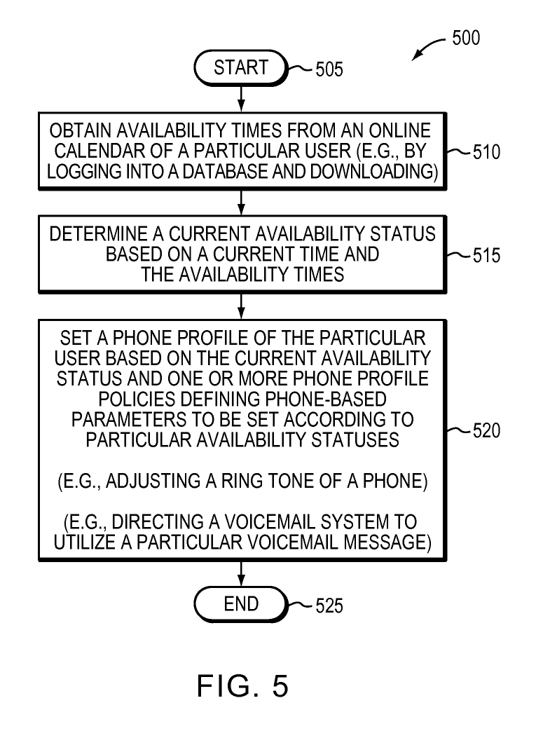

FIGS. 4 and 5 illustrate a simplified example of one or more embodiments herein, such as a logical view 400 of the functionality of phone profile process 346 in FIG. 4, and an accompanying flowchart in FIG. 5 illustrating an example procedure for setting phone profiles based on a user's availability (free/busy) online calendar status. The procedure 500 starts at step 505, and continues to step 510, where availability times (405) from an online calendar 100 of a particular user are obtained. For instance, the calendar may be stored on the particular user's phone/device (calendar 344), or may be stored or managed in a database other than on the phone (e.g., calendar database server 220). In the latter case, the device 300 may log into the database and download the availability times for the calendar (e.g., a “free/busy interface”), accordingly. (Those skilled in the art will appreciate that the access to the online calendar may, though need not, be informative of the actual event types, and may simply indicate availability times.) Generally, the availability times in the calendar may be based on events such as meetings, appointments, work hours, and any user defined time periods (e.g., as illustrated below and with reference to FIG. 1).

By inputting a current time 410 and the obtained availability times 405 to a status engine 420, the device may determine (step 515) a current availability status 415 of the user. For example, if the calendar shows an event from 10-11:00 AM on Tuesday, and the current time was 10:30 AM on Tuesday, then the availability status would indicate that the user is “busy.” Conversely, if no other events existed, and the current time was 11:30 AM on Tuesday (or any other day), then the availability status would be “free.”

The availability status 415 may be supplied to a policy engine 425 (e.g., to apply policies 349, defined as described below), such that in step 520, a phone profile 430 of the particular user may be determined (and set) based on the current availability status and the one or more phone profile policies 349. The policies 349 and/or phone profiles 430 may be configured by the user or by a system programmer/administrator, for instance, as described below. That is, as described in more detail below, the combination of policies and resultant phone profiles may be used to adjusting a ring tone of a phone, and/or to direct a voicemail system to utilize a particular voicemail message. The example procedure 500 ends in step 525, notably with the ability to restart to re-obtain (e.g., update) availability times, or to continue from step 515 where the current time is updated for application to the previously obtained availability times, accordingly.

In accordance with one or more embodiments described herein, the phone device is an actual phone (e.g., mobile phone, IP phone, etc.), and the phone profile relates to the ring tone of the phone. That is, the phone-based parameters defined within the policies 249 may comprise the ring tone to be adjusted/set according to particular availability statuses.

Generally speaking, many smartphones currently have a calendar application 343 that contains the availability time. Phone profile process (application) 346, then, may be configured to read this availability time from the calendar, and thus adjust the ringer (component 347) based on the rules/policies 349, e.g., without user input. Alternatively, phone profile process 346 may be configured to access a calendar program (e.g., from server 220) to obtain the availability times as mentioned above. Note that phone profile process 346 may be installed by the user (e.g., third party software), or it may be an integral part of the phone's original feature set.

The parameters defined within policies 349 may be user defined or a pre-defined set, such as by device manufacturers or software developers, and may illustratively comprise ring tone parameters such as, various volumes, vibrate mode, ringing on/off mode, ring type, do not disturb (DND) mode (e.g., particularly for desktop phones), and send to voicemail mode, each as will be understood by those skilled in the art. In one or more embodiments, availability statuses may be limited to either “free” (available, no events, etc.), “busy” (not available, scheduled event, etc.), and optionally a “tentative” state (e.g., event “E”), such as where an event is scheduled for the user, but the user has yet to confirm attendance (or other indications of an event being tentative, as may be appreciated by those in the art).

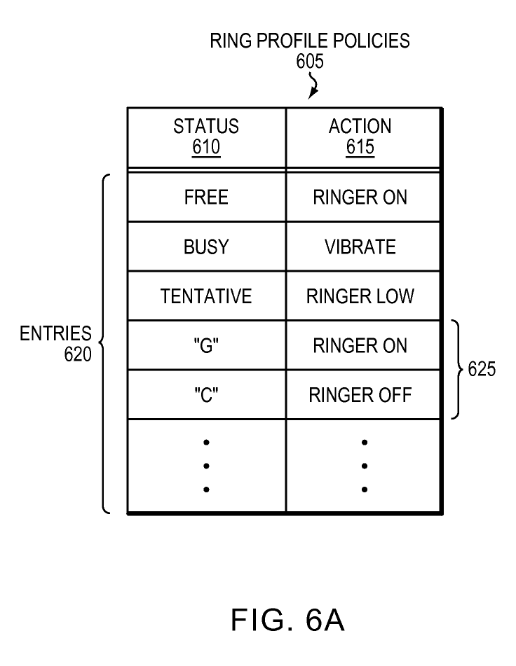

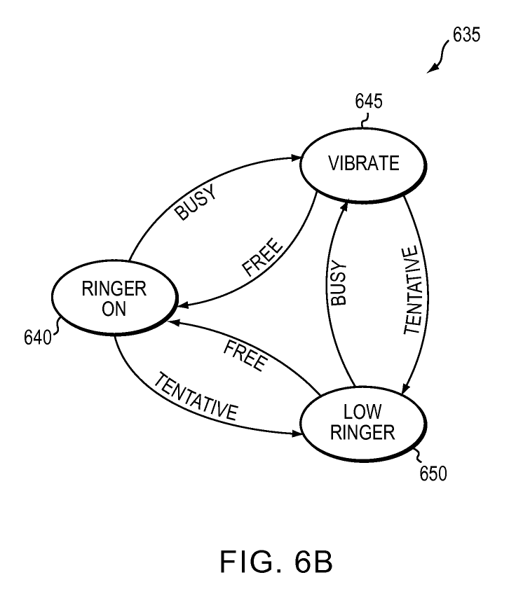

FIG. 6A illustrates an example profile policy mapping 605 as it applies to ring tones that may be a default arrangement or user configured (e.g., from scratch or by adjusting default settings). For example, entries 620 may be populated with fields for the availability status 610 and for the corresponding action 615. Illustratively, one configuration as shown may have the ringer set to “on” in “free” state, “vibrate” in “busy” state, and “ringer low” in “tentative” state. Should the user feel that any parameter should be adjusted, such as changing the ringer to “off” in “busy” state, then the user may configure the policies 605 (349) accordingly.

In addition, in one or more embodiments the availability status may include detailed information regarding the actual event, or at least a type of event, depending upon the capabilities of the calendar and the device obtaining the information. That is, the obtained availability times may indicate a busy event type for busy times, and the phone profile may thus have different parameters based on busy event types. For instance, as shown in FIG. 1, calendar 100 may comprise different types of events, such as meetings, conferences, etc. The user may thus set specified policy mappings 625 that consist of particular event type statuses (or specific events), and their corresponding actions. For example, during a lunch meeting with a client on Thursday (“C”), the user may wish to turn off the phone's ringer completely, rather than have it vibrate as it would during other events (i.e., the more specific policy takes precedence over general policies). On the other hand, the user has illustratively scheduled attending a softball game on Saturday (“G”), and may wish to keep the ringer on during the game. Note that the user may select these particular events/types on the phone itself (configuring policies 349/605), or may indicate on the originating calendar (e.g., when making the appointment) whether the events pertain to a specified policy, and in some embodiments, what that policy is (for example, a tab or selections within the calendar/scheduling program).

The user's phone may thus transition between the various states based on the current availability status. For example, FIG. 6B illustrates an example state diagram 635 of phone profile transitions based on a simple policy-to-profile mapping, e.g., of FIG. 6A (without the user specified policies for events G and C), notably for illustration only. Assume again that the following phone profile policies are configured i) set the ring tone to ringing on mode in response to a free status; ii) set the ring tone to vibrate mode (or off, DND, send to VM, etc.) in response to a busy status; and iii) set the ring tone to a low volume (or vibrate, etc.) in response to a tentative status. Accordingly, assuming that the phone is in a first state 640 of “ringing on,” then in response to a transition to a busy state, the ring tone is changed to vibrate mode in state 645. Alternatively, if transitioning to a tentative state 650, the ringer volume is reduced. Similar logic applies for setting the phone profile in respective directions of the state diagram 635 (from busy, vibrate state 645 to free, ringing state 640, etc.) depending upon the specific transition determined based on the current time, the obtained availability schedule, and the applied policies.

Additionally, in accordance with one or more other embodiments described herein, the phone device is a voicemail system 225, and the phone profile relates to the voicemails used when a caller's call to the particular user's phone is not answered. Illustratively, the voicemail (voice messaging or “VM”) system interfaces the user's calendar through an availability interface to allow the messaging system to know when the person is availability and, in certain embodiments, the nature of the appointment. This can then be mapped to a set of particular voicemail messages that may either be generic and system generated or one or more recorded (generated) by the user (e.g., stored at the voicemail system at component 227), and the voicemail system may be directed to utilize a particular voicemail message based on the current availability status.

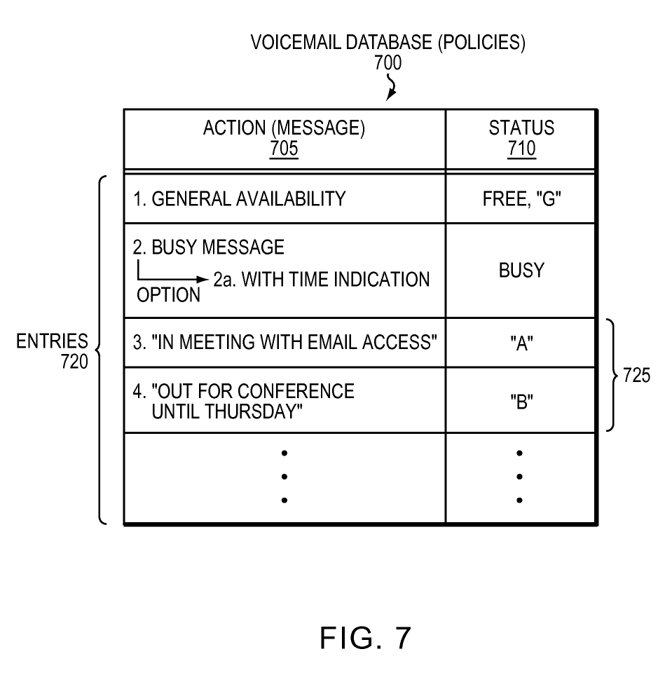

FIG. 7 is an example voicemail database 700 (e.g., an alternative representation of “policies 349”) that may be used to illustrate the techniques described herein. For instance, database 700 may comprise one or more entries 720 comprising an action 705 (e.g., particular voicemail messages) and a corresponding availability status mapping 710. For example, a first message “1” may be used whenever the user is in a “free” state, such as a conventional user-generated greeting, or a system-generated (generic) message of unavailability. On the other hand, a second message “2” may be used when the user's calendar (and the current time) indicates a “busy” status, again, such as a user-generated message (e.g., “I am currently busy in a meeting, and will be available shortly”) or a system-supplied message (e.g., “the user you are trying to reach is currently scheduled for an event . . . ”).

In one or more embodiments, the voicemail system may optionally be configured to include an indication of the actual busy times, such as by including a statement of when the user is scheduled to be free again. Thus, in addition to informing the caller that the user is currently busy, a generated generic voicemail may inform the caller that the user is currently busy, and is scheduled to be free again after a certain time (such as through known techniques to insert a pre-recorded time/number value into the generic recorded messages). Alternatively, the user may record specific messages for the time of day or for particular events, e.g., “I am currently in a meeting please call me after 4:00 PM,” or “I am currently out of the office and will be back by 5:00 PM,” etc.

Also, as noted above, the availability times may indicate a busy event type for busy times. As such, the phone profile may be set by directing the voicemail system to utilize a particular voicemail message based on the busy event type. For instance, specific entries 725 may correspond to particular voicemail messages that the user has recorded for the specific events. Assume, for example, that the user has a recurring meeting “A,” and would like people to know that during this meeting, it is acceptable to remain accessible via email. The user may thus record message “3” indicating such a message, and may configure the voicemail database/policies to play message “3” during meeting “A” (which, notably, may have caused the user's phone ringer being turned off or to vibrate mode as described above, hence the user may not answer the phone even though he/she is available to converse through typed messages). (In certain embodiments, the availability times may indicate a busy event type for busy times corresponding to particular types of “contactability,” that is, whether the user is reachable via certain means of contact (e.g., phone, email, etc.)., in order to prevent a caller from having to call the user's voicemail to find out this contactability information.)

Other specific messages, such as relating to the conference “B” event, may be useful to provide specific information to the callers, such as message “4” informing the callers that the user will be unavailable until after the conference (or vacation, etc.). Additionally, specific types of events may be configured to override default messages, and need not have their own specific message. For instance, assume that the user again has scheduled the softball game on Saturday. If the default “busy” state message indicates that the user is busy (e.g., for a certain time, etc.), the user may simply wish that the normal message (“1”) be used, and may configure the database accordingly.

Advantageously, the novel techniques described herein set phone profiles based on a user's availability online calendar status. In particular, the techniques described above may be used (e.g., by calendar software providers, voicemail servicers, mobile phone providers, etc.) to set the phone ringing profiles based on a user's availability status, as well as using the calendar to intelligently set voicemail messages so the callers can get helpful and informative information about user's availability. For instance, for users who are frequently on the phone or have numerous customer interactions, telling a customer when the user will be available and/or the nature of the non-availability through a voicemail message may be more efficient and may allow the callers to more effectively determine a future course of action (e.g., how and/or when to contact the user). (Note that the technique herein is not merely to record a different voicemail, but to set the particular voicemail that the system will dynamically chose based on the time of day and the obtained availability times from the user's calendar: i.e., without further user intervention, thus regardless of the user's remembering to change the voicemail message.) Moreover, the added convenience to a user of having a phone dynamically adjust the ring tone based on availability status is something that may be appreciated by the users themselves, or more particularly, to the people surrounding the user during such “busy” times.

While there have been shown and described illustrative embodiments that set phone profiles based on a user's availability online calendar status, it is to be understood that various other adaptations and modifications may be made within the spirit and scope of the present invention. For example, the embodiments have been shown and described herein using specific examples of phone profile parameters and/or calendar events. However, the embodiments of the invention in their broader sense are not so limited, and may, in fact, be used with any relevant phone profile parameter and/or calendar events, and the examples given herein are merely illustrative. Also, while the above description is generally directed to phones (e.g., desk phones, smart phones, mobile phones), the techniques may be equally applied to other devices (e.g., smart devices, PDAs, etc.) that have the ability to sync with online calendars, and that may benefit from changing profiles (e.g., adjusting volume, alarms, system sounds, etc.). Further, while the above description illustrates various techniques to obtain the calendar information, other techniques may be used that may be appreciated by those skilled in the art.

Moreover, while the techniques described above make reference to the device itself obtaining the availability times, determining the current status, and setting a phone profile, alternative arrangements may be used within the scope of the embodiments herein. For instance, in one example alternative, calendar database server 220 (or other non-phone device) may push the information to the devices, thus performing the obtaining and determining, and then applying the phone profile policies (e.g., thus stored on the non-phone device) to the current availability status to determine the phone profile. In response to a transition between availability statuses, the calendar server 220 (or other non-phone device) may transmit/send an updated phone profile to the phone device (e.g., a phone or a voicemail system) to ensure that an appropriate phone profile is used by the phone device, accordingly. In other words, while the phone device is one example location where the procedure may be performed, other locations and devices (e.g., singularly or in combination) may be used to perform the techniques described above.

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
obtaining availability times from an online calendar of a particular user;
determining a current availability status based on a current time and the availability times; and
setting a phone profile of the particular user based on the current availability status and one or more phone profile policies, the phone profile policies defining phone-based parameters to be set according to particular availability statuses.

2. The method as in claim 1, wherein setting comprises: adjusting a ring tone of a phone.

3. The method as in claim 2, wherein adjusting comprises: setting a ring tone parameter selected from a group consisting of: volume, vibrate mode, ringing on/off mode, ring type, ring duration, do not disturb (DND) mode, and send to voicemail mode.

4. The method as in claim 2, wherein the phone profile policies are configured as at least one of: i) setting the ring tone to ringing on mode in response to a free status; ii) setting the ring tone to vibrate mode in response to a busy status; and iii) setting the ring tone to a low volume in response to a tentative status.

5. The method as in claim 1, wherein setting comprises: directing a voicemail system to utilize a particular voicemail message.

6. The method as in claim 5, wherein directing comprises: selecting from a plurality of user-generated voicemail messages.

7. The method as in claim 5, wherein directing comprises: selecting from a plurality of generic voicemail messages.

8. The method as in claim 7, wherein the generic voicemail messages indicate availability times.

9. The method as in claim 1, further comprising: applying the phone profile to a phone selected from either a mobile phone or a desktop phone.

10. The method as in claim 1, wherein the calendar is stored on a phone of the particular user.

11. The method as in claim 1, wherein the calendar is stored in a database other than on a phone of the particular user.

12. The method as in claim 11, wherein obtaining comprises:
logging into the database; and
downloading the availability times for the calendar.

13. The method as in claim 1, further comprising:
performing the obtaining and determining at a device other than a phone device on which the phone profile is set;
applying the phone profile policies to the current availability status to determine the phone profile; and
sending the phone profile to the phone device.

14. The method as in claim 1, wherein the availability times indicate a busy event type for busy times, the phone profile having different parameters based on busy event types.

15. The method as in claim 14, wherein setting comprises: directing a voicemail system to utilize a particular voicemail message, the particular voicemail message based on the busy event type.

16. The method as in claim 14, wherein the availability times indicate a busy event type for busy times corresponding to particular types of contactability.

17. The method as in claim 1, wherein the availability times in the calendar are based on events selected from: meetings, appointments, work hours, and user defined time periods.

18. The method as in claim 1, wherein the availability times in the calendar are free/busy times.

19. A tangible computer-readable media having software encoded thereon, the software when executed operable to:
obtain availability times from an online calendar of a particular user;
determine a current availability status based on a current time and the availability times; and
set a phone profile of the particular user based on the current availability status and one or more phone profile policies, the phone profile policies defining phone-based parameters to be set according to particular availability statuses.

20. The tangible computer-readable media as in claim 19, wherein the software is operable to set the phone profile by adjusting a ring tone of a phone.

21. The tangible computer-readable media as in claim 19, wherein the software is operable to set the phone profile by directing a voicemail system to utilize a particular voicemail message.

22. An apparatus, comprising:
a network interface adapted to communicate with a communications network;
a processor coupled to the network interface and adapted to execute one or more processes; and
a memory configured to store a phone profile process executable by the processor, the phone profile process when executed operable to:
obtain availability times from an online calendar of a particular user;
determine a current availability status based on a current time and the availability times; and
set a phone profile of the particular user based on the current availability status and one or more phone profile policies, the phone profile policies defining phone-based parameters to be set according to particular availability statuses.

23. The apparatus as in claim 22, wherein the phone profile process is operable to set the phone profile by one of either adjusting a ring tone of a phone or directing a voicemail system to utilize a particular voicemail message.

24. The apparatus as in claim 22, wherein the apparatus is one of either a phone or a voicemail system.
